(19) United States
(12) Patent Application Publication
(10) Pub. No.: US 2015/0338960 A1
(43) Pub. Date: Nov. 26, 2015

(54) TOUCH PANEL SYSTEM

(71) Applicant: SHARP KABUSHIKI KAISHA, Osaka-shi, Osaka (JP)

(72) Inventors: Manabu YUMOTO, Osaka-shi (JP); Shunsuke NAGASAWA, Osaka-shi (JP)

(73) Assignee: SHARP KABUSHIKI KAISHA, Osaka-shi, Osaka (JP)

(21) Appl. No.: 14/759,058

(22) PCT Filed: Dec. 27, 2013
(86) PCT No.: PCT/JP2013/085153

§ 371 Date: Jul. 2, 2015

(30) Foreign Application Priority Data
Jan. 9, 2013 (JP) 2013-002148

(51) Int. Cl. G06F 3/044

(52) U.S. Cl. CPC G06F 3/044; G06F 2203/04104

(57) ABSTRACT

A touch panel system includes a touch panel and a touch position detecting section for detecting a touch position on the touch panel. The touch position detecting section includes a validity determining section for determining validity of the touch position on the basis of a range set in accordance with at least one of a touch position detected during a touch operation and a moving speed of the touch position detected during the touch operation.

### TECHNICAL FIELD

The present invention relates to a touch panel system and an electronic device including the touch panel system. In particular, the present invention relates to (i) a touch panel system which can prevent erroneous recognition of a touch operation and (ii) an electronic device including the touch panel system.

### BACKGROUND ART

At present, applications of a touch panel system to various electronic devices, e.g., a mobile information device such as a smartphone and a vending machine such as a ticket bending machine, have rapidly been increased. A touch panel mainly used in such a touch panel system has been a resistive film type touch panel. However, in recent years, a projected capacitive type touch panel is becoming popular because of its capability of accepting multi-touch.

As an example of such a touch panel system, Patent Literature 1 discloses a command input device. The command input device includes a touch panel, a touch time detecting section, a touch frequency detecting section, a touch interval detecting section, and an input command determining section. The touch time detecting section detects time during which a finger is continuously making contact with the touch panel. The touch frequency detecting section detects the number of times that the finger touches the touch panel. The touch interval detecting section detects an interval from when the finger is off from the touch panel and to when the finger makes contact with the touch panel. The input command determining section determines an input command on the basis of detection results of the touch time detecting section, the touch frequency detecting section, and the touch interval detecting section.

FIG. 11 is a flowchart for describing an operation of the command input device disclosed in Patent Literature 1. As illustrated in FIG. 11, the command input device is arranged such that: (i) a command can be inputted on the basis of time, a frequency, and an interval of touch by the finger to the touch panel (S501 to 507); (ii) a command is determined on the basis of the inputted command (S508); (iii) an operation is selected on the basis of the determined command (S509); and (iv) the touch panel is controlled in accordance with the selected operation (S510).

### CITATION LIST

### Patent Literature 1

Japanese Patent Application Publication, Tokukai, No. 2004-362429 (Publication Date: Dec. 24, 2004)

### SUMMARY OF INVENTION

### Technical Problem

However, a conventional touch panel system has a problem that the conventional touch panel system recognizes, as a touch position, noise which has occurred during a touch operation.

Specifically, the conventional touch panel system detects a touch position at every predetermined time so that a touch position (a current touch position) at a certain time point is recognized. Thus, in a case where noise has occurred on a touch panel, not only (i) a touch position that is supposed to be recognized but also (ii) a position of the noise is recognized as touch positions. As a result, noise which has occurred at a position far distant from a previous touch position is erroneously recognized as a touch position.

The command input device disclosed in Patent Literature 1 is intended to be applied to a car navigation device. The command input device determines an inputted command on the basis of contentious touch time, a touch frequency, and a touch time interval, with respect to the touch panel. From this, a driver does not need to look at the touch panel when inputting a command while driving, and the driver can accurately input a command even in a case where a vehicle is shaking. With the configuration, the command input device also erroneously recognizes, as a touch position, noise which has occurred at a position far distant from a previous touch position.

The present invention is attained in view of the above conventional problem. An object of the present invention is to provide a touch panel system and the like that can prevent erroneous recognition of a touch operation.

### Solution to Problem

In order to attain the above object, a touch panel system according to one aspect of the present invention includes: a touch panel; and a touch position detecting section for detecting a touch position on the touch panel, the touch position detecting section including: a validity determining section for determining validity of the touch position based on a range set in accordance with at least one of a touch position detected during a touch operation and a moving speed of the touch position detected during the touch operation.

### Advantageous Effects of Invention

According to one aspect of the present invention, it is possible to prevent erroneous recognition of a touch operation.

### BRIEF DESCRIPTION OF DRAWINGS

FIG. 1 is a view schematically illustrating a touch panel system according to Embodiment 1 of the present invention.

FIG. 2 is a block diagram illustrating a validity determining section of the touch panel system illustrated in FIG. 1.

FIG. 3 is a flowchart illustrating a process of the validity determining section of the touch panel system illustrated in FIG. 1.

FIG. 4 is a view schematically illustrating the process of the validity determining section of the touch panel system illustrated in FIG. 1

FIG. 5 is a flowchart illustrating a process of the validity determining section of the touch panel system according to Embodiment 2 of the present invention.

FIG. 6 is a view schematically illustrating the process of the validity determining section of the touch panel system according to Embodiment 2 of the present invention.

FIG. 7 is a flowchart illustrating a process of the validity determining section of the touch panel system according to Embodiment 3 of the present invention.

FIG. 8 is a view schematically illustrating the process of the validity determining section of the touch panel system according to Embodiment 3 of the present invention.

FIG. 9 is a view schematically illustrating another process of the validity determining section of the touch panel system according to Embodiment 3 of the present invention.

FIG. 10 is a block diagram illustrating a configuration of a mobile phone according to Embodiment 4 of the present invention.

FIG. 11 is a flowchart for describing an operation of a command input device disclosed in Patent Literature 1.

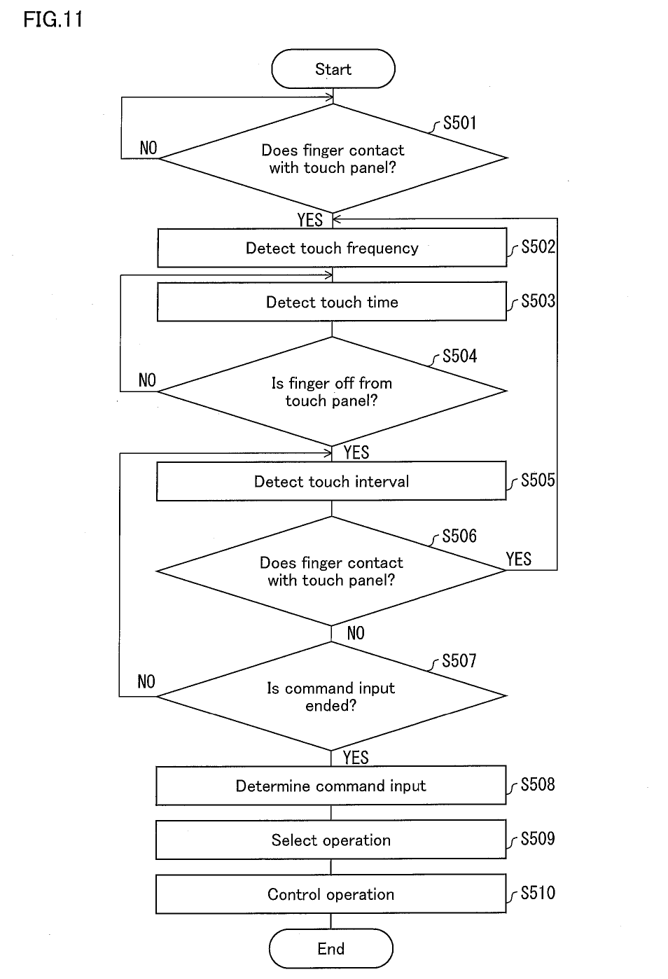

### DESCRIPTION OF EMBODIMENTS

### Embodiment 1

(Configuration of Touch Panel System 1)

The following discusses embodiments of the present invention in detail. Note, in the following description, that the wording “A to B” stands for “A or more and B or less”.

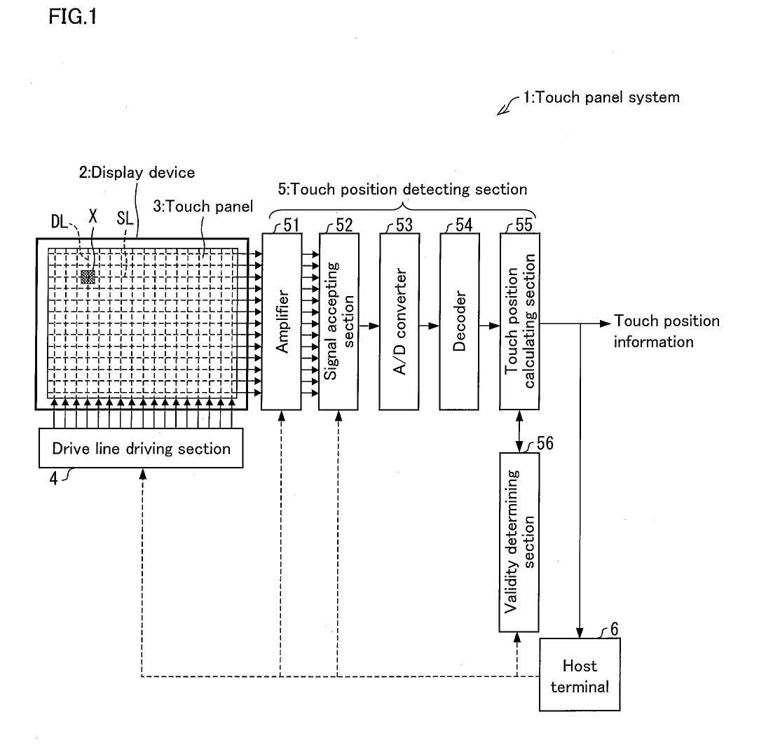

FIG. 1 is a view schematically illustrating a basic configuration of a touch panel system 1 according to Embodiment 1 of the present invention. As illustrated in FIG. 1, the touch panel system 1 includes a display device 2, a touch panel 3, a drive line driving section 4, a touch position detecting section 5, and a host terminal 6. The following description assumes that a side on which a user carries out a touch operation is a front surface (or an upper side).

The display device 2 has a display surface on which various icons for operations, character information corresponding to operational instructions by the user, and the like are to be displayed. The display device 2 is made up of, for example, a liquid crystal display, a plasma display, an organic EL display, a field emission display (FED), or the like. These displays are widely used in electrical devices for daily use, so that the touch panel system 1 has high versatility. The display device 2 can be arbitrarily configured, and an arrangement of the display device 2 is not specifically limited.

To the touch panel 3, the user inputs various operational instructions by carrying out a touch (push) operation with respect to a surface of the touch panel 3 with an indicator such as his/her finger or a pen. The touch panel 3 is stacked on the front surface (upper surface) of the display device 2 so as to cover the display surface of the display device 2. In the present embodiment, a projected capacitive type touch panel is used as the touch panel 3. The capacitive touch panel 3 has advantages such as high light transmittance and high durability. However, a type of the touch panel 3 is not limited to the projected capacitive type and can be another type. The type of the touch panel 3 can be, for example, a resistive film type, an electromagnetic inductive type, an ultrasonic surface acoustic wave type, or an infrared scanning type.

Specifically, the touch panel 3 includes a plurality of drive lines DL which are provided along the display surface so as to be parallel to each other, and a plurality of sense lines SL which are provided along the display surface so as to be parallel to each other and intersect with the plurality of drive lines DL in a grade separation manner. At each of intersections of the plurality of drive lines DL and the plurality of sense lines SL, a capacitor is formed. The plurality of drive lines DL and the plurality of sense lines SL can be made of, for example, (i) a transparent wiring material such as indium tin oxide (ITO) or (ii) a metallic mesh. The plurality of drive lines DL and the plurality of sense lines SL are connected to the display device 2 (a panel unit which constitutes a part of the display surface). Note that FIG. 1 deals with an example in which the plurality of drive lines DL and the plurality of sense lines SL vertically intersect with each other in a grade separation manner, but the plurality of drive lines DL and the plurality of sense lines SL can alternatively intersect with each other in a grade separation manner at any angle other than a vertical direction.

The drive line driving section 4 is connected with the plurality of drive lines DL and, when the touch panel system 1 is activated, the drive line driving section 4 applies electrical potentials to the plurality of the drive lines DL at constant intervals. The drive line driving section 4 causes the plurality of sense lines SL, which intersect with the plurality of drive lines DL in the grade separation manner, to generate condition signals by driving the plurality of drive lines DL. The condition signal is a signal which indicates a condition of a touch at or near the intersections (hereinafter, referred to as a “detection region” (detection region X illustrated in FIG. 1)) of the plurality of drive lines DL and the plurality of sense lines SL on the touch panel 3.

A value of the condition signal varies in accordance with the capacitance between the drive line DL and the sense line SL, and indicates whether the indicator is in contact with or is being near to the detection region X on the touch panel 3. That is, the condition signal indicates (i) the presence or absence of the indicator being in contact with or being near to the detection region X, (ii) a distance between the detection region X and the indicator, or the like. Note that, as the indicator comes closer to the detection region X or when the indicator is in contact with the detection region X, the capacitance becomes smaller.

The touch position detecting section 5 processes a signal supplied from the touch panel 3 so as to detect a touch position. That is, the touch position detecting section 5 detects a position of the touch by the indicator, which is in contact with or is being near to the display surface, by processing the condition signal generated on the sense line SL. The touch position detecting section 5 includes, from a touch panel 3 side, an amplifier 51, a signal accepting section 52, an A/D converter 53, a decoder 54, a touch position calculating section 55, and a validity determining section 56 in this order.

The amplifier 51 amplifies the condition signals generated on the plurality of sense lines SL. The signal accepting section 52 accepts the condition signals amplified by the amplifier 51 and supplies the amplified condition signals in a time division manner. The A/D converter 53 converts the condition signals, which have been supplied from the signal accepting section 52 and are analog signals, into respective digital signals. The decoder 54 calculates, on the basis of the digital signals converted by the A/D converter 123, a changed amount of capacity distribution in the touch panel 3. The touch position calculating section 55 calculates, on the basis of the changed amount of the capacity distribution calculated by the decoder 54, a position of the touch on the touch panel 3, and then generates touch position information indicative of the calculated position of the touch. The validity determining section 56 detects, during a touch operation in progress, at least one of (i) a current touch position with respect to a previous touch position and (ii) a moving speed of the current touch position with respect to that of the previous touch position. Then, the validity determining section 56 determines, on the basis of a result of the detection, validity of the current touch position. The validity determining section 56 will be described later in detail.

The host terminal 6 controls the plurality of drive lines DL which are driven by the drive line driving section 4. The host terminal 6 also controls the plurality of sense lines SL which generate the condition signals to be processed by the touch position detecting section 5. The following description deals with an example in which the host terminal 6 controls the plurality of drive lines DL and the plurality of sense lines SL. Note, however, that the host terminal 6 can alternatively control only the plurality of drive lines DL or the plurality of sense lines SL.

(Basic Operation of Touch Panel System 1)

Next, the following discusses an example of a basic operation of the touch panel system 1 with reference to FIG. 1. Note that the following discusses a single trial operation in which the touch panel system 1 detects an indicator that is in contact with or is being near to the touch panel 3.

First, the drive line driving section 4 drives the plurality of drive lines DL so that condition signals are generated on the plurality of sense lines SL. Next, the amplifier 51 amplifies the condition signals generated on the plurality of sense lines SL. Further, the signal accepting section 52 supplies the condition signals, which have been amplified by the amplifier 51, in a time division manner. Note that the host terminal 6 controls operation of each of the drive line driving section 4, the amplifier 51, and the signal accepting section 52. That is, the host terminal 6 controls the plurality of drive lines DL to be driven and the plurality of sense lines SL on which condition signals to be processed are generated.

Next, the A/D converter 53 converts the analog signals, which have been supplied from the signal accepting section 52, into respective digital signals each having a predetermined number of bits. Subsequently, the decoder 54 calculates, on the basis of the digital signals converted by the A/D converter 53, a changed amount of capacity distribution in the touch panel 3. For example, before a touch operation is detected, the decoder 54 obtains digital signals indicative of a case where a touch subject (indicator) does not exist on the touch panel 3 and calculates in advance capacity distribution of the case where the touch subject (indicator) does not exist on the touch panel 3. The decoder 54 then receives from the A/D converter 53 digital signals indicative of a case where the indicator has been detected and calculates capacity distribution of the case where the indicator is present. After that, the decoder 54 compares the pre-calculated capacity distribution of the case where the touch subject is absent with the capacity distribution of the case where the touch subject is present, so as to calculate a changed amount of the capacity distribution. This changed amount of the capacity distribution can be rephrased as an amount by which capacitance is changed due to the touch subject (indicator).

The touch position calculating section 55 calculates, on the basis of the changed amount of the capacity distribution calculated by the decoder 54, a position of the touch subject on the touch panel 3, and generates touch position information. The touch position calculating section 55 calculates the position of the touch subject on the touch panel 3 by, for example, determining that the touch subject exists at a position at which the changed amount of the capacitance is larger than a threshold for determining a touch.

The validity determining section 56 determines validity of the touch position on the basis of a range set in accordance with at least one of a touch position detected during a touch operation and a moving speed of the touch position detected during the touch operation.

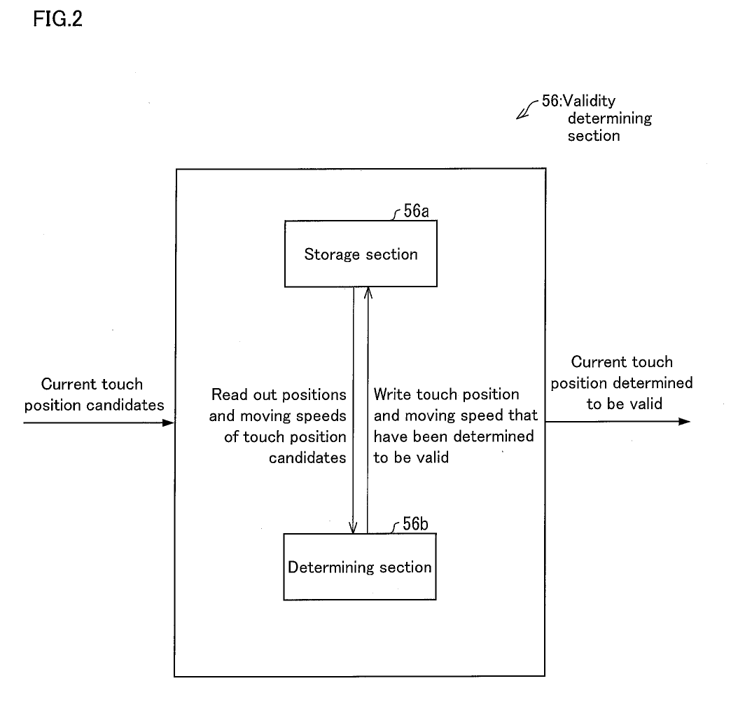

Next, the following discusses an example of the validity determining section 56 with reference to FIG. 2. FIG. 2 is a block diagram illustrating a configuration of the validity determining section 56 in the touch panel system 1 illustrated in FIG. 1. As illustrated in FIG. 2, the validity determining section 56 includes a storage section 56a and a determining section 56b.

The storage section 56a stores (i) relative time of the touch position calculated by the touch position calculating section 55, (ii) the touch position, and (iii) a moving speed of the touch position. The touch positions calculated by the touch position calculating section 55 may include noise erroneously recognized as a touch position. Note that the storage section 56a calculates the moving speed of the touch position on the basis of a movement amount and movement time between arbitrary two touch positions.

The determining section 56b reads out, from the storage section 56a, a previous touch position and a moving speed of the previous touch position and determines, from touch position candidates on the touch panel 3, a touch position that is supposed to be detected. That is, the determining section 56b eliminates erroneously recognized touch positions (noise) from the touch position candidates to determine a correct touch position (validity of touch positions). During a touch operation, the determining section 56b reads out at least one of the touch position and the moving speed of the touch position which are stored in the storage section 56b, and sets a condition based on which the determination is carried out. Then, the determining section 56b determines validity of touch positions on the basis of the condition thus set. Specifically, in a case where the condition is satisfied, the determining section 56b determines that the touch position or a moving speed of the touch position is valid and that the touch is made by an indicator. On the other hand, in a case where the condition is not satisfied, the determining section 56b determines that the touch position or a moving speed of the touch position is not valid and that the touch is not made by an indicator (i.e., determines that the touch is caused by noise). The process of the determining section 56b will be described later in detail.

The touch panel system 1 continuously detects the indicator that is the touch subject by repeating the trial operation described above.

With reference to the touch position information supplied from the touch position calculating section 55 as necessary, the host terminal 6 can control each section of the drive line driving section 4 and the touch position detecting section 5. Further, the host terminal 6 can control a frame rate, which is the number of times that the touch position detecting section 5 attempts to detect a touch subject per unit time (e.g., per second). That is, in the touch panel system 1, the host terminal 6 can arbitrarily control settings of (i) the plurality of drive lines DL which are supposed to be driven by the drive line driving section 4, (ii) the plurality of sense lines SL on which the condition signals to be processed by the touch position detection section 5 are supposed to be generated, (iii) the frame rate, (iv) detection sensitivity, and the like.

(Process of Validity Determining Section 56)

Next, the following discusses in detail the validity determining section 56 which is a characteristic feature of the touch panel system 1. In the touch panel system 1, the touch position detecting section 5 detects a touch position at every predetermined time, so that a touch position (current touch position) at a certain time point is recognized. Thus, in a case where noise has occurred on the touch panel 3, not only a touch position that is supposed to be recognized but also a position of the noise is recognized as touch positions. As a result, noise which has occurred at a position far distant from a previous touch position is erroneously recognized as a touch position.

The touch panel system 1 includes the validity determining section 56 for prevention of such erroneous recognition. The validity determining section 56 determines a correct touch position on the basis of at least one of a touch position and a moving speed of the touch position.

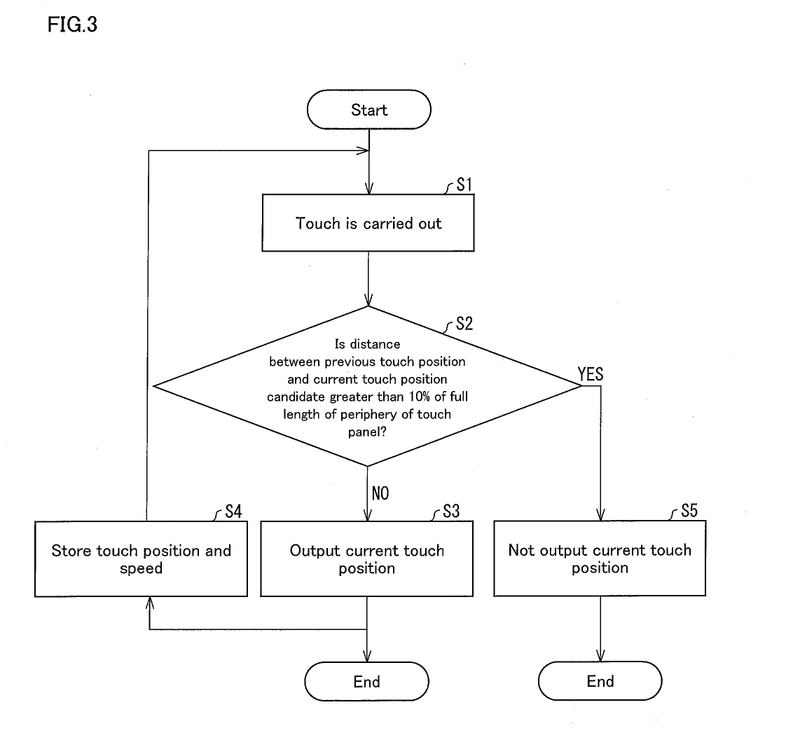

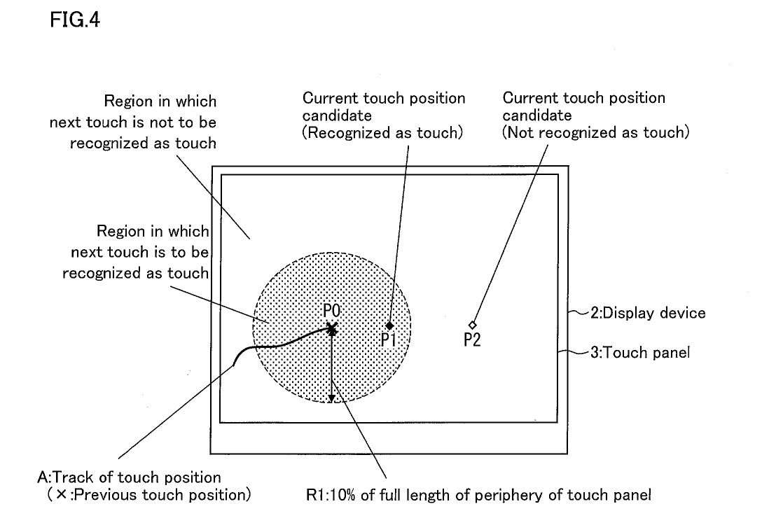

The following discusses, with reference to FIGS. 3 and 4, an example in which the validity determining section 56 determines a touch position on the basis of a touch position. FIG. 3 is a flowchart illustrating a process of the validity determining section 56 of the touch panel system 1 illustrated in FIG. 1. FIG. 4 is a view schematically illustrating the process of the validity determining section 56 of the touch panel system 1 illustrated in FIG. 1.

As described above, the touch position detecting section 5 processes a signal supplied from the touch panel 3 so as to detect a touch position. Specifically, when a touch operation is carried out with respect to the touch panel 3 (S1), the touch position calculating section 55 calculates a current touch position on the basis of a changed amount of capacitance of the touch panel 3, and supplies a result of the calculation to the validity determining section 56 (see FIG. 3). This current touch position has not been subjected to the process of the validity determining section 56, and therefore the current touch position is a current touch position candidate (i.e., a touch position whose validity is to be determined). In the validity determining section 56, the determining section 56b first reads out information indicative of the current touch position candidate and, from the storage section 56a, information indicative of a previous touch position detected immediately before the current touch position candidate. Further, the determining section 56b determines whether or not a distance between the previous touch position and the current touch position candidate is greater than 10% of a full length of a periphery of the touch panel 3 (S2).

The following discusses determination of the determining section 56b with reference to FIG. 4. In an example of FIG. 4, a track A of a touch position and two current touch position candidates P1 (♦) and P2 (⋄) are shown. An end “x” of the track A of the touch position indicates a previous touch position P0. The determining section 56b sets a range (indicated by a dotted-line circle illustrated in FIG. 4) whose center is the previous touch position P0 and radius R1 is 10% of the full length of the periphery (i.e., a total length of 4 sides) of the touch panel 3. The determining section 56b determines validity of the touch position candidates P1 and P2 on the basis of the range thus set. The determining section 56b determines that a touch position candidate is a valid touch position only in a case where, for example, that touch position candidate is detected inside the range. In FIG. 4, the current touch position candidate P1 is detected inside the range, so that the determining section 56b determines that the current touch position candidate P1 is a valid touch position. On the other hand, the current touch position candidate P2 is detected outside the range and is far distant from the range. Thus, the determining section 56b determines that the touch position candidate P2 is not a valid touch position but is an invalid touch position caused by noise.

As such, in a case where a touch operation is carried out at the touch position candidate P1, the determining section 56b determines that the touch position (touch operation) is of a next touch which follows a previous touch (i.e., determines that the touch position is a valid touch position) (S3). The determining section 56b then supplies, to the touch position calculating section 55, information which indicates that the touch position candidate P1 is the current touch position, and supplies a position and a moving speed of the touch position candidate P1 to the storage section 56a so that these pieces of information are stored in the storage section 56a (S4).

On the other hand, in a case where a touch operation is carried out at the touch position candidate P2, the determining section 56b determines that the touch position (touch operation) is not of a next touch that follows the previous touch (i.e., determines that the touch position is not a valid touch position). Thus, the determining section 56b does not supply, to the touch position calculating section 55, information which indicates that the touch position candidate P2 is the current touch position (S5).

In the example of FIG. 4, the validity determining section 56 sets the range whose radius is 10% of the full length of the periphery of the touch panel 3. Note, however, that the radius is not limited to this, provided that the range can distinguish the touch position candidate P1 from the touch position candidate P2. The radius of the range is preferably 6% to 10%, more preferably 7% to 9%, particularly preferably 7% to 8% of the full length of the periphery of the touch panel 3. With the setting of the range, the touch position candidate P1 that is supposed to be detected is reliably distinguished from the invalid touch position candidate P2 caused by noise. Consequently, it is possible to eliminate the invalid touch position candidate P2 caused by noise and to detect the correct touch position candidate P1 as the current touch position.

Note that FIG. 4 deals with the example in which the validity determining section 56 determines the touch position on the basis of only a touch position. However, the validity determining section 56 may determine the touch position on the basis of at least one of a touch position and a moving speed of a touch position.

As described above, in the touch panel system 1, the touch position detecting section 5 includes the validity determining section 56 that determines validity of the touch position on the basis of the range set in accordance with at least one of a touch position detected during the touch operation and a moving speed of the touch position detected during the touch operation.

That is, the validity determining section 56 (i) sets the range (indicated by a dotted-line circle illustrated in FIG. 4), based on which validity of a touch position is determined, in accordance with at least one of a touch position detected during the touch operation and a moving speed of the touch position detected during the touch operation and (ii) determines validity of the touch position (the touch position candidates P1 and P2) on the basis of the range thus set. From this, in a case where a touch position recognized at a certain time point or a moving speed of the touch position (i.e., a current touch position or a moving speed of the current touch position) is, as the touch position candidate P2, extremely different from a previous touch position recognized immediately before the certain time point or a moving speed of the previous touch position, the touch position recognized at the certain time point or the moving speed of the touch position is far distant from the set range. Thus, the touch position that is supposed to be detected (i.e., the touch position candidate P1) is distinguished from the invalid touch position (i.e., the touch position candidate P2) caused by noise. Consequently, it is possible to prevent erroneous recognition of a touch position.

Further, in the touch panel system 1, the validity determining section 56 determines that a touch position is valid only in a case where that touch position is detected inside the range.

According to the arrangement, the validity determining section 56 determines that only a touch position detected inside the set range (i.e., only the touch position candidate P1) is a valid touch position that is supposed to be detected, and that a touch position detected outside the set range (i.e., the touch position candidate P2) is an invalid touch position. As such, the invalid touch position caused by noise (i.e., a touch position candidate lacking validity) is eliminated from touch positions detected by the touch position detecting section 5. Consequently, it is possible to reliably prevent erroneous recognition of a touch position.

Furthermore, in the touch panel system 1, the validity determining section 56 preferably sets, as the range, a circular region whose (i) center is the previous touch position P0 that is detected immediately before the touch position whose validity is to be determined and (ii) radius is 6% to 10% of the full length of the periphery of the touch panel 3.

According to the arrangement, the validity determining section 56 sets the range whose radius (i) corresponds to a distance between (a) a certain touch position whose validity is to be determined and (b) a previous touch position that is detected immediately before the certain touch position and (ii) is 6% to 10% of the full length of the periphery of the touch panel 3. Further, the validity determining section 56 determines validity of the certain touch position on the basis of the range thus set. From this, the touch position that is supposed to be detected is reliably distinguished from the invalid touch position caused by noise. Consequently, it is possible to eliminate the invalid touch position caused by noise and to detect a correct touch position.

### Embodiment 2

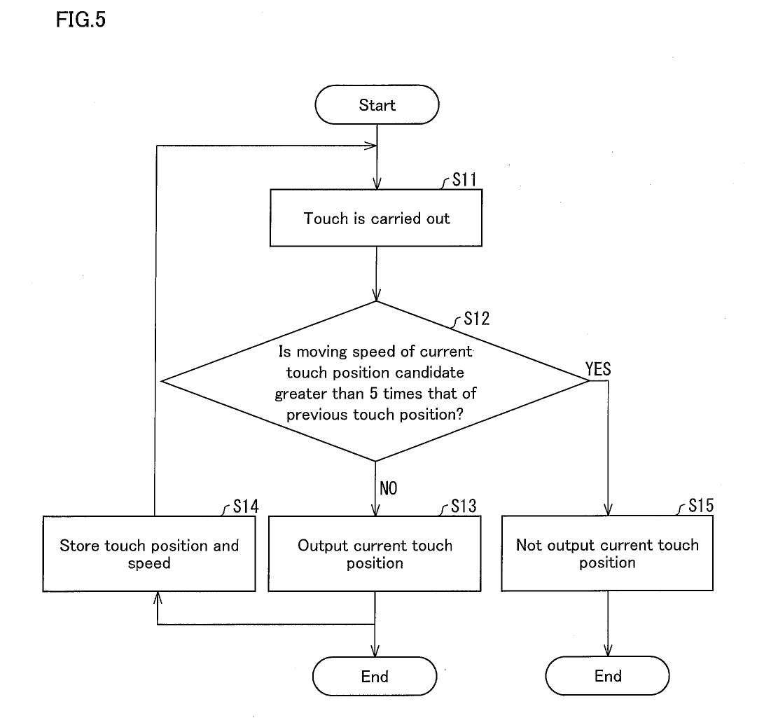

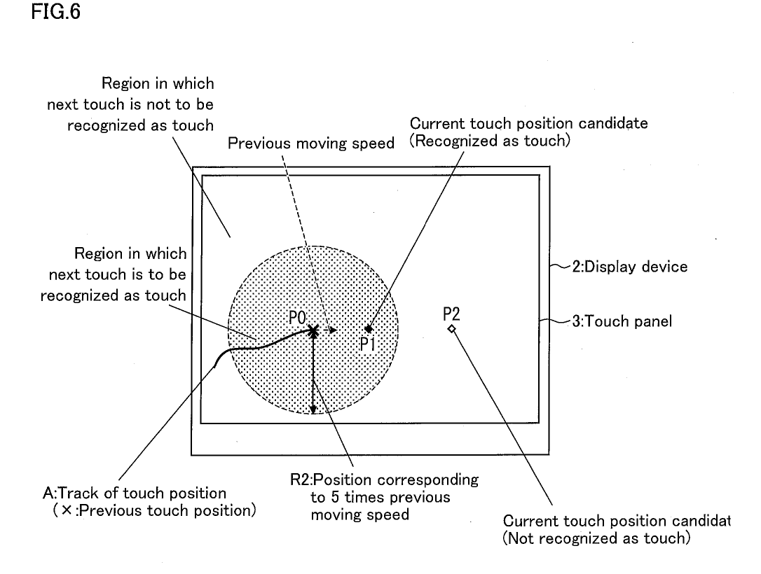

Another embodiment of the present invention is described below with reference to FIGS. 5 and 6. Note that, for convenience, identical reference numerals are given to members having respective functions identical to those of the members described in Embodiment 1, and descriptions of those members are omitted in Embodiment 2. Further, the following particularly discusses a difference from Embodiment 1, i.e., a process of the validity determining section 56.

(Another Process of Validity Determining Section 56)

In Embodiment 2, the validity determining section 56 sets, as the range, a region whose (i) center is a previous touch position P0 that is detected immediately before a touch position whose validity is to be determined and (ii) radius is 4 times to 5 times a moving speed of the previous touch position.

FIG. 5 is a flowchart illustrating the process of the validity determining section 56 of the touch panel system 1 according to Embodiment 2 of the present invention. FIG. 6 is a view schematically illustrating the process of the validity determining section 56 of the touch panel system according to Embodiment 2 of the present invention.

Specifically, when a touch operation is carried out with respect to the touch panel 3 (S11), the touch position calculating section 55 calculates a current touch position on the basis of a changed amount of capacitance of the touch panel 3, and supplies a result of the calculation to the validity determining section 56 (see FIG. 5). This current touch position has not been subjected to the process of the validity determining section 56, and therefore the current touch position is a current touch position candidate (i.e., a touch position whose validity is to be determined). In the validity determining section 56, the determining section 56b first reads out information indicative of the current touch position candidate and, from the storage section 56a, information indicative of a previous touch position detected immediately before the current touch position candidate. Further, the determining section 56b determines whether or not a moving speed of the current touch position candidate is greater than 5 times the moving speed of the previous touch position (S12).

The following discusses determination of the determining section 56b with reference to FIG. 6. In an example of FIG. 6, a track A of a touch position and two current touch position candidates P1 (♦) and P2 (⋄) are shown. An end “x” of the track A of the touch position indicates a previous touch position P0. The determining section 56b sets a range (indicated by a dotted-line circle illustrated in FIG. 6) whose center is the previous touch position P0 and radius R2 is 5 times a moving speed of the previous touch position P0. The determining section 56b determines validity of the touch position candidates P1 and P2 on the basis of the range thus set. The determining section 56b determines that a touch position candidate is a valid touch position only in a case where, for example, that touch position candidate is detected inside the range. In FIG. 6, the current touch position candidate P1 is detected inside the range, so that the determining section 56b determines that the current touch position candidate P1 is a valid touch position. On the other hand, the current touch position candidate P2 is detected outside the range and is far distant from the range. Thus, the determining section 56b determines that the touch position candidate P2 is not a valid touch position but is an invalid touch position caused by noise.

As such, in a case where a touch operation is carried out at the touch position candidate P1, the determining section 56b determines that the touch position (touch operation) is of a next touch which follows a previous touch (i.e., determines that the touch position is a valid touch position) (S13). The determining section 56b then supplies, to the touch position calculating section 55, information which indicates that the touch position candidate P1 is the current touch position, and supplies a position and a moving speed of the touch position candidate P1 to the storage section 56a so that these pieces of information are stored in the storage section 56a (S14).

On the other hand, in a case where a touch operation is carried out at the touch position candidate P2, the determining section 56b determines that the touch position (touch operation) is not of a next touch that follows the previous touch (i.e., determines that the touch position is not a valid touch position). Thus, the determining section 56b does not supply, to the touch position calculating section 55, information which indicates that the touch position candidate P2 is the current touch position (S15).

In the example of FIG. 6, the validity determining section 56 sets the range whose radius is 5 times the moving speed of the previous touch position P0. Note, however, that the radius is not limited to this, provided that the range can distinguish the touch position candidate P1 from the touch position candidate P2. The radius of the range is preferably 3 times to 5 times, more preferably 3.5 times to 4.5 times, particularly preferably 3.5 times to 4 times the moving speed of the previous touch position P0. With the setting of the range, the touch position candidate P1 that is supposed to be detected is reliably distinguished from the invalid touch position candidate P2 caused by noise. Consequently, it is possible to eliminate the invalid touch position candidate P2 caused by noise and to detect the correct touch position candidate P1 as the current touch position.

As such, in Embodiment 2, the validity determining section 56 sets, as the range, a region whose center is a previous touch position and radius is 3 times to 5 times a moving speed of the previous touch position, the previous touch position having been detected immediately before a touch position whose validity is to be determined.

That is, the validity determining section 56 sets the range whose (i) center is a previous touch position that is detected immediately before a certain touch position whose validity is to be determined and (ii) radius is 3 times to 5 times the moving speed of the previous touch position. Further, the validity determining section 56 determines validity of the certain touch position on the basis of the range thus set. From this, the touch position that is supposed to be detected is reliably distinguished from the invalid touch position caused by noise. Consequently, it is possible to eliminate the invalid touch position caused by noise and to detect a correct touch position.

### Embodiment 3

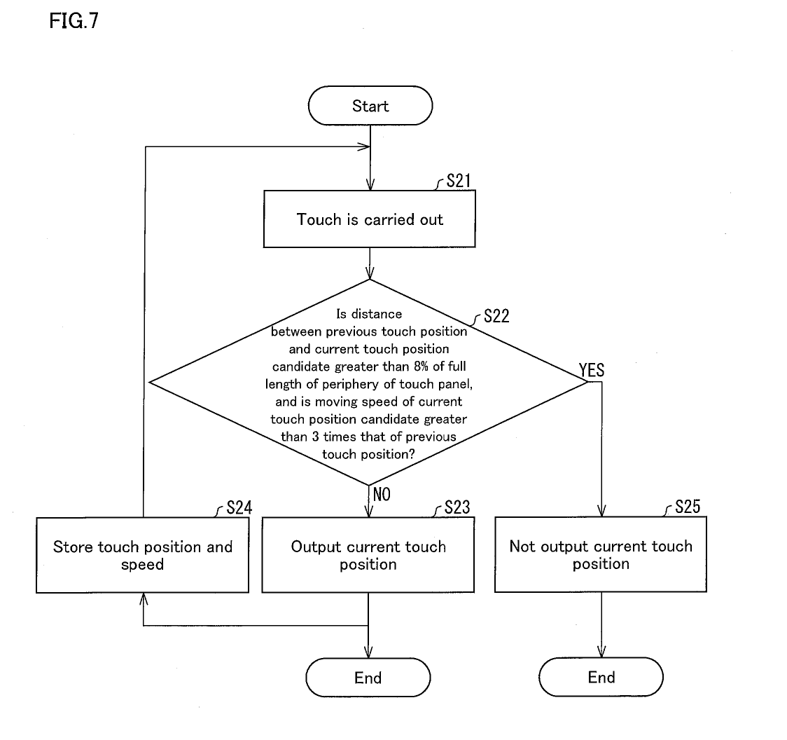

Still another embodiment of the present invention is described below with reference to FIGS. 7 through 9. Note that, for convenience, identical reference numerals are given to members having respective functions identical to those of the members described in Embodiments 1 and 2, and descriptions of those members are omitted in Embodiment 3. Further, the following particularly discusses a difference from Embodiments 1 and 2, i.e., a process of the validity determining section 56. In short, the process of the validity determining section 56 of Embodiment 3 is a combination of those of Embodiments 1 and 2.

(Still Another Process of Validity Determining Section 56)

In Embodiment 3, the validity determining section 56 sets, as the range, (i) a first region whose center is a previous touch position and radius is 4% to 8% of a full length of a periphery of the touch panel and (ii) a second region whose center is the previous touch position and radius is twice to 3 times a moving speed of the previous touch position, the previous touch position having been detected immediately before a touch position whose validity is to be determined; and the validity determining section 56 determines that a touch position is valid in a case where the touch position is detected inside both of the first region and the second region.

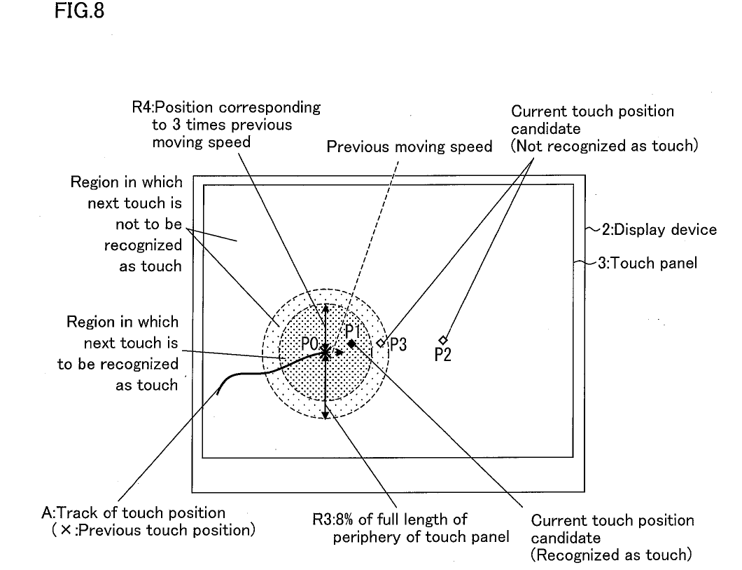

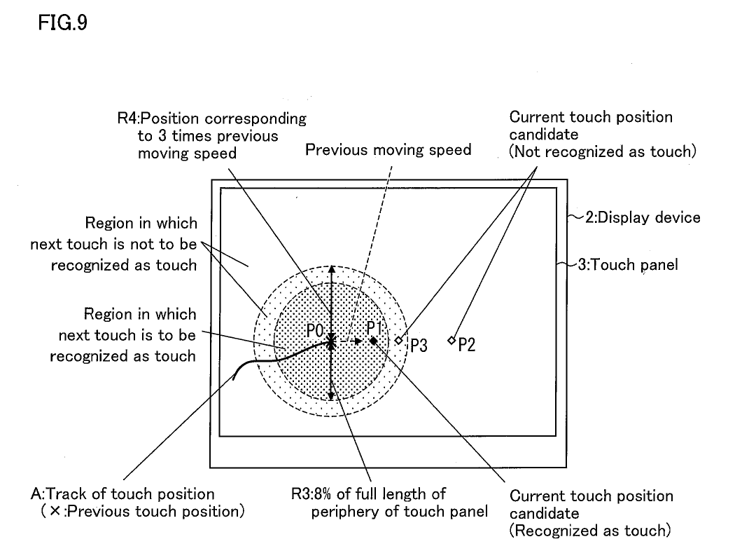

FIG. 7 is a flowchart illustrating the process of the validity determining section 56 of the touch panel system 1 according to Embodiment 2 of the present invention. FIG. 8 is a view schematically illustrating the process of the validity determining section 56 of the touch panel system according to Embodiment 3 of the present invention. FIG. 9 is a view schematically illustrating another process of the validity determining section 56 of the touch panel system according to Embodiment 3 of the present invention.

Specifically, when a touch operation is carried out with respect to the touch panel 3 (S21), the touch position calculating section 55 calculates a current touch position on the basis of a changed amount of capacitance of the touch panel 3, and supplies a result of the calculation to the validity determining section 56 (see FIG. 7). This current touch position has not been subjected to the process of the validity determining section 56, and therefore the current touch position is a current touch position candidate (i.e., a touch position whose validity is to be determined). In the validity determining section 56, the determining section 56b first reads out information indicative of the current touch position candidate and, from the storage section 56a, information indicative of a previous touch position detected immediately before the current touch position candidate. Further, the determining section 56b determines whether or not (i) a distance between the previous touch position and the current touch position is greater than 8% of the full length of the periphery of the touch panel 3 and (ii) a moving speed of the current touch position is greater than 3 times the moving speed of the previous touch position (S22).

The following discusses determination of the determining section 56b with reference to FIGS. 8 and 9. In examples of FIGS. 8 and 9, a track A of a touch position and three current touch position candidates P1 (♦), P2 (⋄), and P3 (⋄) are shown. An end “x” of the track A of the touch position indicates a previous touch position P0. Note that FIGS. 8 and 9 are different from each other only in that a moving speed of the previous touch position is relatively small in FIG. 8 and is relatively large in FIG. 9. FIGS. 8 and 9 show the same basic concept and illustrate separate cases merely for convenience. Thus, in the following description, FIGS. 8 and 9 are not particularly distinguished.

The determining section 56b sets (a) a range (indicated by an outer dotted-line circle illustrated in FIG. 8) whose center is the previous touch position P0 and radius R3 is 8% of the full length of the periphery (i.e., a total length of 4 sides) of the touch panel 3 and (b) a range (indicated by an inner dotted-line circle illustrated in FIG. 8) whose center is the previous touch position P0 and radius R4 is 3 times the moving speed of the previous touch position P0. Note that, in comparison between FIGS. 8 and 9, the ranges of (a) and (b) are larger in FIG. 9, in which the moving speed of the previous touch position is relatively large.

The determining section 56b determines validity of the touch position candidates P1, P2, and P3 on the basis of the ranges (a) and (b) thus set. The determining section 56b determines that a touch position candidate is a valid touch position only in a case where, for example, that touch position candidate is detected inside both of the ranges (a) and (b). In FIGS. 8 and 9, the current touch position candidate P1 is detected inside both of the ranges (a) and (b), so that the determining section 56b determines that the current touch position candidate P1 is a valid touch position.

On the other hand, the current touch position candidate P2 is detected outside the ranges (a) and (b) and is far distant from the ranges (a) and (b). Thus, the determining section 56b determines that the current touch position candidate P2 is not the valid touch position but is an invalid touch position caused by noise.

Furthermore, the current touch position candidate P3 is detected inside the range (a) and outside the range (b). Thus, the determining section 56b determines that the current touch position candidate P2 is not the valid touch position but is an invalid touch position caused by noise.

As such, in a case where a touch operation is carried out at the touch position candidate P1, the determining section 56b determines that the touch position (touch operation) is of a next touch which follows a previous touch (i.e., determines that the touch position is a valid touch position) (S23). The determining section 56b then supplies, to the touch position calculating section 55, information which indicates that the touch position candidate P1 is the current touch position, and supplies a position and a moving speed of the touch position candidate P1 to the storage section 56a so that these pieces of information are stored in the storage section 56a (S24).

On the other hand, in a case where a touch operation is carried out at the touch position candidate P2 or P3, the determining section 56b determines that the touch position (touch operation) is not of a next touch that follows the previous touch (i.e., determines that the touch position is not a valid touch position). Thus, the determining section 56b does not supply, to the touch position calculating section 55, information which indicates that each of the touch position candidates P2 and P3 is the current touch position (S25).

In the examples of FIGS. 8 and 9, the validity determining section 56 sets (a) the range whose radius is 8% of the full length of the periphery of the touch panel 3 and (b) the range whose radius is 3 times the moving speed of the previous touch position P0. Note, however, that the radius is not limited to these, provided that the range can distinguish the touch position candidate P1 from the touch position candidate P2. The radius of the range (a) is preferably 4% to 8%, more preferably 5% to 7.5%, particularly preferably 6% to 7% of the full length of the periphery of the touch panel 3. Further, the radius of the range (b) is preferably twice to 3 times, particularly preferably twice to 2.5 times the moving speed of the previous touch position P0. With the setting of the range, the touch position candidate P1 that is supposed to be detected is reliably distinguished from the invalid touch position candidate P2 caused by noise. Consequently, it is possible to eliminate the invalid touch position candidates P2 and P3 caused by noise and to detect the correct touch position candidate P1 as the current touch position.

As such, in Embodiment 3, the validity determining section 56 sets, as the range, (i) a first region whose center is a previous touch position and radius is 4% to 8% of a full length of a periphery of the touch panel and (ii) a second region whose center is the previous touch position and radius is twice to 3 times a moving speed of the previous touch position, the previous touch position having been detected immediately before a touch position whose validity is to be determined; and the validity determining section determines that a touch position is valid in a case where the touch position is detected inside both of the first region and the second region.

That is, the validity determining section 56 sets (a) the range whose radius (i) corresponds to a distance between a certain touch position whose validity is to be determined and a previous touch position that is detected immediately before the certain touch position and (ii) is 2% to 8% of the full length of the periphery of the touch panel 3 and (b) the range whose (i) center is the previous touch position and (ii) radius is twice to 3 times the moving speed of the previous touch position. Then, the validity determining section 56 determines validity of a touch position on the basis of whether or not that touch position is detected inside both of the set ranges (a) and (b). From this, the touch position that is supposed to be detected is reliably distinguished from the invalid touch position caused by noise. Consequently, it is possible to eliminate the invalid touch position caused by noise and to detect a correct touch position. As such, the validity determining section determines validity of a touch position with the use of two parameters which are the full length of the periphery of the touch panel and the moving speed of the previous touch position. Therefore, it is possible to more reliably prevent erroneous recognition of a touch position.

### Embodiment 4

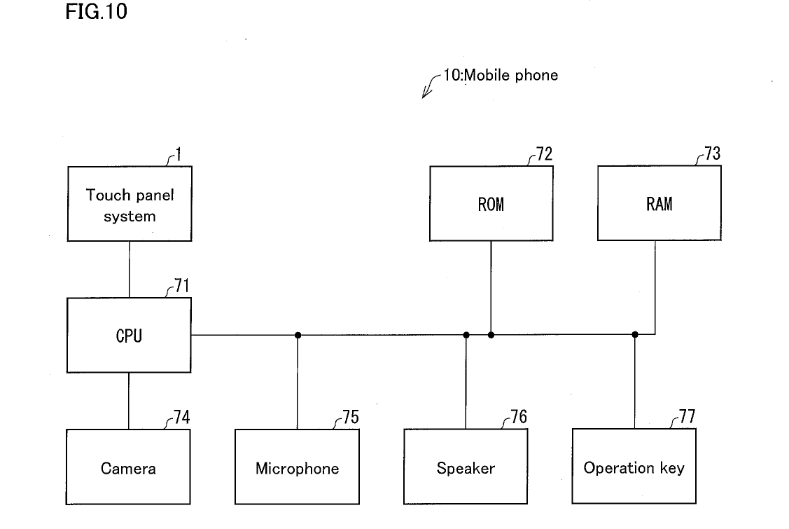

FIG. 10 is a functional block diagram illustrating a configuration of a mobile phone 10 including the touch panel system 1. The mobile phone (electronic device) 10 includes a CPU 71, a RAM 73, a ROM 72, a camera 74, a microphone 75, a speaker 76, an operation key 77, and the touch panel system 1. These components are connected to each other via a data bus.

The CPU 71 controls an operation of the mobile phone 10. The CPU 71 executes a program stored in, for example, the ROM 72. The operation key 77 is used by a user of the mobile phone 10 to enter instructions. The RAM is a volatile memory which stores therein (i) data generated when the CPU 71 has executed the program or (ii) data entered via the operation key 77. The ROM 72 is an involatile memory which stores data therein.

The ROM 72 is a ROM, such as an erasable programmable read-only memory (EPROM) or a flash memory, into which data can be written or from which data can be deleted. Note that, although not illustrated in FIG. 10, the mobile phone 10 can have an interface (IF) for being connected with another electronic apparatus via a wire.

The camera 74 takes an image of a subject in accordance with a user's operation of the operation key 77. Note that the image data of the subject thus taken is stored in the RAM 73 or an external memory (e.g., a memory card). The microphone 75 accepts audio from a user. The mobile phone 10 digitizes the audio (analog data) thus accepted, and transmits the audio thus digitized to a destination (such as other mobile phone). The speaker 76 outputs sounds based on data such as music data stored in the RAM 73.

The CPU 71 controls an operation of the touch panel system 1. The CPU 71 executes a program stored in, for example, the ROM 72. The RAM 73 is a volatile memory which stores therein data generated when the CPU 71 has executed the program. The ROM 72 is an involatile memory which stores data therein. The touch panel system 1 displays images stored in the ROM 72 and/or in the RAM 73.

Further, the present invention can be described as the following.

[Main Points]

A touch panel system 1 according to an aspect of the present invention includes: a touch panel; and a touch position detecting section for detecting a touch position on the touch panel, the touch position detecting section including: a validity determining section for determining validity of the touch position based on a range set in accordance with at least one of a touch position detected during a touch operation and a moving speed of the touch position detected during the touch operation.

According to the arrangement, the validity determining section (i) sets the range, based on which validity of a touch position is determined, in accordance with at least one of a touch position detected during the touch operation and a moving speed of the touch position detected during the touch operation and (ii) determines validity of the touch position on the basis of the range thus set. From this, in a case where a touch position recognized at a certain time point or a moving speed of the touch position (i.e., a current touch position or a moving speed of the current touch position) is extremely different from a previous touch position recognized immediately before the certain time point or a moving speed of the previous touch position, the touch position recognized at the certain time point or the moving speed of the touch position is far distant from the set range. Thus, the touch position that is supposed to be detected is distinguished from the invalid touch position caused by noise. Consequently, it is possible to prevent erroneous recognition of a touch position.

Note that the command input device disclosed in Patent Literature 1 determines an input command without depending on a touch starting position on a touch panel. Thus, it is not possible to prevent erroneous recognition of, as a touch position, noise which has been occurred at a position far distant from a previous touch position.

The touch panel system 1 according to an aspect of the present invention can be arranged such that the validity determining section determines that a touch position is valid only in a case where the touch position is detected inside the range.

According to the arrangement, the validity determining section determines that only a touch position detected inside the set range is a valid touch position that is supposed to be detected, and that a touch position detected outside the set range is an invalid touch position. As such, the invalid touch position caused by noise (i.e., a touch position candidate lacking validity) is eliminated from touch positions detected by the touch position detecting section. Consequently, it is possible to reliably prevent erroneous recognition of a touch position.

The touch panel system 1 according to an aspect of the present invention can be arranged such that the validity determining section sets, as the range, a region whose center is a previous touch position and radius is 6% to 10% of a full length of a periphery of the touch panel, the previous touch position having been detected immediately before a touch position whose validity is to be determined.

According to the arrangement, the validity determining section sets the range whose radius (i) corresponds to a distance between (a) a certain touch position whose validity is to be determined and (b) a previous touch position that is detected immediately before the certain touch position and (ii) is 6% to 10% of the full length of the periphery of the touch panel. Further, the validity determining section determines validity of the certain touch position on the basis of the range thus set. From this, the touch position that is supposed to be detected is reliably distinguished from the invalid touch position caused by noise. Consequently, it is possible to eliminate the invalid touch position caused by noise and to detect a correct touch position.

The touch panel system 1 according to an aspect of the present invention can be arranged such that the validity determining section sets, as the range, a region whose center is a previous touch position and radius is 3 times to 5 times a moving speed of the previous touch position, the previous touch position having been detected immediately before a touch position whose validity is to be determined.

According to the arrangement, the validity determining section sets the range whose (i) center is a previous touch position that is detected immediately before a certain touch position whose validity is to be determined and (ii) radius is 3 times to 5 times the moving speed of the previous touch position. Further, the validity determining section 56 determines validity of the certain touch position on the basis of the range thus set. From this, the touch position that is supposed to be detected is reliably distinguished from the invalid touch position caused by noise. Consequently, it is possible to eliminate the invalid touch position caused by noise and to detect a correct touch position.

The touch panel system 1 according to an aspect of the present invention can be arranged such that the validity determining section sets, as the range, (i) a first region whose center is a previous touch position and radius is 4% to 8% of a full length of a periphery of the touch panel and (ii) a second region whose center is the previous touch position and radius is twice to 3 times a moving speed of the previous touch position, the previous touch position having been detected immediately before a touch position whose validity is to be determined; and the validity determining section determines that a touch position is valid in a case where the touch position is detected inside both of the first region and the second region.

According to the arrangement, the validity determining section sets (a) the range whose radius (i) corresponds to a distance between a certain touch position whose validity is to be determined and a previous touch position that is detected immediately before the certain touch position and (ii) is 4% to 8% of the full length of the periphery of the touch panel, and (b) the range whose (i) center is the previous touch position and (ii) radius is twice to 3 times the moving speed of the previous touch position. Then, the validity determining section determines validity of a touch position on the basis of whether or not that touch position is detected inside both of the set ranges (a) and (b). From this, the touch position that is supposed to be detected is reliably distinguished from the invalid touch position caused by noise. Consequently, it is possible to eliminate the invalid touch position caused by noise and to detect a correct touch position. As such, the validity determining section determines validity of a touch position with the use of two parameters which are the full length of the periphery of the touch panel and the moving speed of the previous touch position. Therefore, it is possible to more reliably prevent erroneous recognition of a touch position.

The touch panel system 1 according to an aspect of the present invention can be arranged such that the touch panel is a projected capacitive type touch panel.

According to the above configuration, since the touch panel system 1 includes the touch panel whose operation principle is the projected capacitive type, it is possible to provide a touch panel system capable of accepting multi-touch (multi-point detection).

The touch panel system 1 according to an aspect of the present invention can further include a display device and can be arranged such that the touch panel is provided on a front surface of the display device.

According to the arrangement, since the touch panel is provided on the front surface of the display device, it is possible to prevent erroneous recognition of noise as a touch position which noise has occurred in the display device.

The touch panel system 1 according to an aspect of the present invention can be arranged such that the display device is a liquid crystal display, a plasma display, an organic EL display, or a field emission display.

According to the above configuration, the display device is made up of any of the above displays that are widely used in electrical devices for daily use. This makes it possible to provide a touch panel system having high versatility.

An electronic device according to an aspect of the present invention includes any one of the above described touch panel systems.

Therefore, it is possible to provide an electronic device that can prevent erroneous recognition of a touch operation.

The present invention is not limited to the description of the embodiments above, but may be altered by a skilled person within the scope of the claims. An embodiment based on a proper combination of technical means disclosed in different embodiments is encompassed in the technical scope of the present invention. Further, the technical means disclosed in different embodiments can be combined so as to form a new technical feature.

### INDUSTRIAL APPLICABILITY

The present invention is applicable to various electronic devices each of which includes a touch panel. The various electronic devices encompass a television, a personal computer, a mobile phone, a digital camera, a portable game device, an electronic photo frame, a mobile information terminal, an electronic book, household electric appliances, a ticket vending machine, an ATM, a car navigation device, and the like.

### REFERENCE SIGNS LIST

1 Touch Panel System

2 Display Device

3 Touch Panel

4 Drive Line Driving Section

5 Touch Position Detecting Section

6 Host Terminal

10 Mobile Phone (Electronic Device)

56 Validity Determining Section

56a Storage Section

56b Determining Section

1. A touch panel system comprising:
a touch panel; and
a touch position detecting section for detecting a touch position on the touch panel,
the touch position detecting section including:
a validity determining section for determining validity of the touch position based on a range set in accordance with at least one of a touch position detected during a touch operation and a moving speed of the touch position detected during the touch operation.

2. The touch panel system as set forth in claim 1, wherein:
the validity determining section determines that a touch position is valid only in a case where the touch position is detected inside the range.

3. The touch panel system as set forth in claim 1, wherein:
the validity determining section sets, as the range, a region whose center is a previous touch position and radius is 6% to 10% of a full length of a periphery of the touch panel, the previous touch position having been detected immediately before a touch position whose validity is to be determined.

4. The touch panel system as set forth in claim 1, wherein:
the validity determining section sets, as the range, a region whose center is a previous touch position and radius is 3 times to 5 times a moving speed of the previous touch position, the previous touch position having been detected immediately before a touch position whose validity is to be determined.

5. The touch panel system as set forth in claim 1, wherein:
the validity determining section sets, as the range, (i) a first region whose center is a previous touch position and radius is 4% to 8% of a full length of a periphery of the touch panel and (ii) a second region whose center is the previous touch position and radius is twice to 3 times a moving speed of the previous touch position, the previous touch position having been detected immediately before a touch position whose validity is to be determined; and
the validity determining section determines that a touch position is valid in a case where the touch position is detected inside both of the first region and the second region.

6. The touch panel system as set forth in claim 2, wherein:
the validity determining section sets, as the range, a region whose center is a previous touch position and radius is 6% to 10% of a full length of a periphery of the touch panel, the previous touch position having been detected immediately before a touch position whose validity is to be determined.

7. The touch panel system as set forth in claim 2, wherein:
the validity determining section sets, as the range, a region whose center is a previous touch position and radius is 3 times to 5 times a moving seed of the previous touch position the previous touch position having been detected immediately before a touch position whose validity is to be determined.

8. The touch panel system as set forth in claim 2, wherein:
the validity determining section sets, as the range, (i) a first region whose center is a previous touch position and radius is 4% to 8% of a full length of a periphery of the touch panel and ii a second re ion whose center is the previous touch position and radius is twice to 3 times a moving speed of the previous touch position, the previous touch position having been detected immediately before a touch position whose validity is to be determined; and
the validity determining section determines that a touch position is valid in a case where the touch position is detected inside both of the first region and the second region.
